(19) United States
(12) Patent Application Publication
(10) Pub. No.: US 2025/0279584 A1
(43) Pub. Date: Sep. 4, 2025

(54) CIRCULARLY POLARIZED ANTENNA AND INTELLIGENT TERMINAL

(71) Applicant: GUANGDONG COROS SPORTS TECHNOLOGY CO., LTD, Dongguan (CN)

(72) Inventor: Xianwei SHI, Dongguan (CN)

(21) Appl. No.: 19/209,999

(22) Filed: May 16, 2025

Related U.S. Application Data
(63) Continuation of application No. PCT/CN2022/139995, filed on Dec. 19, 2022.

(51) Int. Cl. H01Q 9/04

(52) U.S. Cl. CPC H01Q 9/0428; H01Q 9/045

(57) ABSTRACT

Provided are a circularly polarized antenna and an intelligent terminal. The circularly polarized antenna includes an annular radiator and a first feed terminal. A first breakpoint is provided on the radiator, and a first capacitor or a first inductor is connected in series with the radiator at the first breakpoint. One end of the first feed terminal is electrically connected to the radiator, and another end of the first feed terminal is electrically connected to a first feed module of a mainboard. When a capacitor or inductor is connected in series with the radiator at the first breakpoint, the resonance frequencies of a first mode and a second mode excited on the radiator which are mutually perpendicular will both change, so that the difference between the resonance phase of the first mode and the resonance phase of the second mode reaches 90°, thereby the circular polarization is realized.

### CROSS-REFERENCE TO RELATED APPLICATIONS

This application claims priority to and is a continuation of International Application No. PCT/CN2022/139995, filed on Dec. 19, 2022, the entire content of which is incorporated herein by reference.

### FIELD

The present application relates to the field of antenna technology, more particularly to a circularly polarized antenna and an intelligent terminal.

### BACKGROUND

With the development of intelligent terminals (e.g., mobile phones, wearable devices, computers, etc.), satellite positioning has become one of its main functions. In order to achieve the purpose of satellite positioning and trajectory recording, satellite positioning antennas are indispensable. In order to enhance the transmission efficiency from satellite to the ground (e.g., to enhance penetration and coverage area, etc.), the transmitting antenna of the satellite towards the ground adopts the form of circular polarization. Similarly, in order to enhance the receiving capability of the positioning antenna, the receiving antenna of the terminal device should also adopt the same circularly polarized antenna as the transmitting antenna.

However, in the related technologies, due to the limitations of size or industrial design of intelligent terminals, it is difficult to implement circularly polarized antennas. Instead, linearly polarized antennas are commonly adopted, which leads to poor satellite positioning performance of intelligent terminals.

### SUMMARY

One objective of the embodiments of the present application is to provide a circularly polarized antenna and an intelligent terminal to solve the problem of poor satellite positioning performance caused by the use of linearly polarized antennas in terminal devices.

Technical solutions adopted in the embodiment of the present application are as follows:

In accordance with a first aspect, an embodiment of the present application provides a circularly polarized antenna, including:
an annular radiator, a first breakpoint is provided on the annular radiator, and a first capacitor or a first inductor is connected in series with the annular radiator at the first breakpoint; and
a first feed terminal, one end of the first feed terminal is electrically connected to the annular radiator, and the other end of the first feed terminal is electrically connected to a first feed module of a mainboard.

In accordance with a second aspect, an intelligent terminal is provided, including the circularly polarized antenna described in the first aspect.

Beneficial effects of the first aspect provided by the embodiments of the present application include are as follows: in the circularly polarized antenna provided by the embodiments of the present application, an annular radiator and a first feed terminal are included. A first breakpoint is provided on the radiator, a first capacitor or a first inductor is connected in series with the radiator at the first breakpoint, one end of the first feed terminal is electrically connected to the radiator, and the other end of the first feed terminal is electrically connected to a first feed module of a mainboard.

When a capacitor is connected in series with the radiator at the first breakpoint, the equivalent distributed inductance of the radiator decreases due to the offset effect of the capacitor, and the resonant frequencies of the first mode and the second mode of the radiator both increase, and the resonant current of the first mode of the radiator and the resonant current of the second mode of the radiator are perpendicular to each other. In case that the first breakpoint is located both in the current weak zone of the first mode and the current strong zone of the second mode, for the first mode, the series-connected capacitor has a relatively small impact on the original current distribution of the radiator, and the increase in the resonant frequency of the first mode of the radiator is relatively small. For the second mode, the series-connected capacitor has a relatively large impact on the original current distribution of the radiator, and the increase in the resonant frequency of the second mode of the radiator is relatively large. By adjusting the position of the first breakpoint and/or the capacitance of the capacitor, the difference between the resonant phase of the first mode and the resonant phase of the second mode is enabled to reach 90°, and then the radiator forms a circularly polarized antenna.

When the inductor is connected in series with the radiator at the first breakpoint, the inductance of the equivalent distributed inductance of the radiator will increase, the resonant frequency of the first mode and the second mode of the radiator will both decrease, and the resonant current of the first mode of the radiator and the resonant current of the second mode of the radiator are perpendicular to each other. In case that the first breakpoint is located both in the current weak zone of the first mode and the current strong zone of the second mode, for the first mode, the series-connected inductor has a relatively small impact on the original current distribution of the radiator, and the reduction in the resonant frequency of the first mode of the radiator is relatively small. For the second mode, the series-connected inductor has a relatively large impact on the original current distribution of the radiator, and the reduction in the resonant frequency of the second mode of the radiator is relatively large. By adjusting the position of the first breakpoint and/or the inductance of the inductor, the difference between the resonant phase of the first mode and the resonant phase of the second mode is enabled to reach 90°, and then the radiator forms a circularly polarized antenna.

It thus can be concluded that when the capacitor or inductor is connected in series with the radiator at the first breakpoint, the resonance frequencies of a first mode and a second mode excited on the radiator which are perpendicular to each other will both change, so that the difference between the resonance phase of the first mode and the resonance phase of the second mode reaches 90°, thereby the circular polarization is realized.

Therefore, the circularly polarized antenna provided in the embodiments of the present application only needs to use one annular radiator, which reduces the number of radiators, reduces the occupied space of the circularly polarized antenna, contributes to the miniaturization design of the intelligent terminal, and improves the satellite positioning performance of terminal devices.

Beneficial effect of the second aspect provided in the embodiments of the present application is the same as the beneficial effects of the first aspect mentioned above, references can be made to the beneficial effect of the first aspect mentioned above.

### BRIEF DESCRIPTION FOR DRAWINGS

To illustrate technical schemes in the embodiments of the present application more clearly, the drawings required to be used in description of the embodiments or exemplary technologies will be briefly introduced below. Obviously, the drawings in the following description are merely some embodiments of the present application. For ordinary technicians in this field, other drawings may also be obtained based on these drawings without paying any creative efforts.

FIG. 1 is a schematic diagram of a resonant frequency of a complete circular ring-shaped radiator in a first mode and a second mode provided by an embodiment of the present application;

FIG. 2 is a schematic diagram of a three-dimensional structure of a circularly polarized antenna provided by an embodiment of the present application;

FIG. 3 is a schematic structural diagram of a circularly polarized antenna provided by an embodiment of the present application;

FIG. 4 is a schematic structural diagram of a circularly polarized antenna provided by another embodiment of the present application;

FIG. 5 is a schematic structural diagram of a circularly polarized antenna provided by another embodiment of the present application;

FIG. 6 is a schematic structural diagram of a circularly polarized antenna provided by another embodiment of the present application;

FIG. 7 is a schematic structural diagram of a circularly polarized antenna provided by another embodiment of the present application;

FIG. 8 is a schematic structural diagram of a circularly polarized antenna provided by another embodiment of the present application;

FIG. 9 is a schematic structural diagram of a circularly polarized antenna provided by another embodiment of the present application;

FIG. 10 is a schematic structural diagram of a circularly polarized antenna provided by another embodiment of the present application;

FIG. 11 is a schematic structural diagram of a circularly polarized antenna provided by another embodiment of the present application;

FIG. 12 is a schematic structural diagram of a circularly polarized antenna provided by another embodiment of the present application; and

FIG. 13 is a schematic structural diagram of a circularly polarized antenna provided by another embodiment of the present application.

In the figures: 100, radiator; 101, current strong zone; 102, current weak zone; 200, first feed terminal; 300, first breakpoint; 400, mainboard; 500, second breakpoint; and 600, second feed terminal.

### DETAILED DESCRIPTION OF EMBODIMENTS

To make the objectives, technical solutions and advantages of the present application clearer and more explicit, the present application is further described in detail in conjunction with the accompanying drawings and embodiments. It should be understood that the specific embodiments described herein are merely used to explain the present application and are not intended to limit the present application.

It should be noted that various steps recorded in a method implementation of the present application may be performed in different orders and/or in parallel. In addition, the method implementation may include additional steps and/or omit the steps shown. The scope of the present application is not limited in this regard. The term “including” and its variations used herein are open inclusions, that is, “including but not limited to”. The term “based on” means “at least partially based on”. The term “an embodiment” means “at least one embodiment”. The term “another embodiment” means “at least one other embodiment”. The term “some embodiments” means “at least some embodiments”. The relevant definitions of other terms will be given in the following description. It should be noted that the concepts of “first” and “second” mentioned in the present application are only used to distinguish different devices, modules or units, and are not used to limit the order or interdependence of the functions performed by these devices, modules or units.

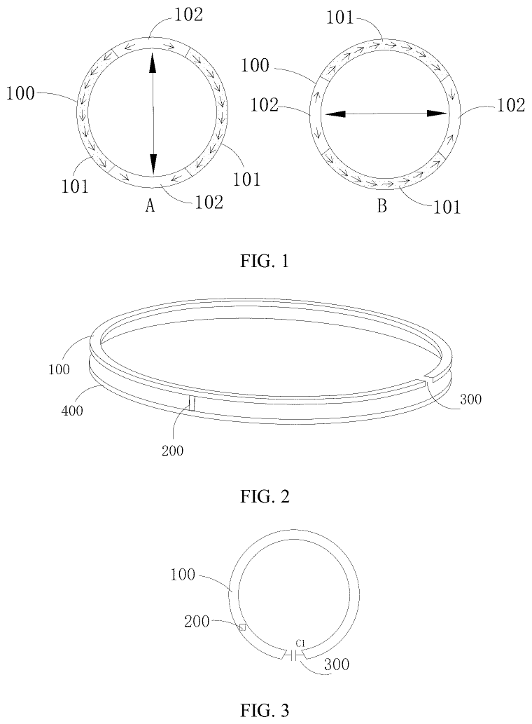

As shown in FIG. 1, when there is no breakpoint on the radiator 100, that is, the radiator 100 is a complete circular ring, a resonant current of the radiator 100 in a first mode (such as pattern A in FIG. 1) and a resonant current of the radiator 100 in a second mode (such as pattern B in FIG. 1) are perpendicular to each other, have the same amplitude, and have the same phase (that is, the same resonant frequency). In this case, the radiator 100 is equivalent to a linearly polarized antenna.

The resonant current of the radiator 100 in the first mode is shown in pattern A of FIG. 1. Though pattern A of FIG. 1 only shows that the resonant current flows from top to bottom, the resonant current may also flow from bottom to top. The density of arrows in pattern A of FIG. 1 represents the magnitude of the current. The areas with dense arrows are current strong zones 101, and the areas outside the current strong zones 101 are current weak zones 102. Each current weak zone 102 contains a current zero point. It thus can be seen that the radiator 100 in the first mode includes two current strong zones 101 and two current weak zones 102.

The resonant current of the radiator 100 in the second mode is shown in pattern B of FIG. 1. Though pattern B of FIG. 1 only shows that the resonant current flows from left to right, and the resonant current may also flow from right to left. The density of arrows in pattern B of FIG. 1 represents the magnitude of the current. The areas with dense arrows are the current strong zones 101, and the areas outside the current strong zones 101 are the current weak zones 102. Each current weak zone 102 contains a current zero point. It thus can be seen that the radiator 100 in the second mode includes two current strong zones 101 and two current weak zones 102.

As shown in FIG. 2, the circularly polarized antenna includes an annular radiator 100 and a first feed terminal 200. Herein, a first breakpoint 300 is provided on the radiator 100, a first capacitor C1 or a first inductor L1 is connected in series with the radiator at the first breakpoint 300, one end of the first feed terminal 200 is electrically connected to the radiator 100, and the other end of the first feed terminal 200 is electrically connected to a first feed module of a mainboard 400.

Particularly, the radiator 100 is arranged parallel to the mainboard 400, and there is a certain interval between the radiator 100 and the mainboard 400. The distance between the radiator 100 and the mainboard 400 may be set according to actual needs, for example, the distance between the radiator 100 and the mainboard 400 may be set to 2 to 5 mm. The mainboard 400 is the main printed circuit board (PCB, Printed Circuit Board) of an intelligent terminal, and the mainboard 400 is integrated with a processor and a corresponding feed module. The radiator 100 is electrically connected to the mainboard 400 through the first feed terminal 200, thereby forming an antenna structure. The connection point between the first feed terminal 200 and the radiator 100 is called a feed point, and the feed point is arranged at a position where the resonant current of the first mode of the radiator 100 is close to the resonant current of the second mode of the radiator 100. Optionally, the feed point is arranged at a position where the resonant current or electric field of the radiator 100 in the first mode and the second mode are equal. The length of the first breakpoint 300 may be set according to actual needs. For example, the length of the first breakpoint 300 is set to 3 to 5 mm, the first capacitor C1 or the first inductor L1 may be arranged on the mainboard 400, and the first capacitor C1 and the first sensor may also be arranged at the first breakpoint 300.

In some embodiments, the radiator 100 may be made of conductive materials including metals, alloys, etc.

As shown in FIG. 3, when the first capacitor C1 is connected in series with the radiator at the first breakpoint 300 on the radiator 100, the equivalent distributed inductance of the radiator 100 decreases due to an offset effect of the capacitor, and the resonant frequency of the first mode of the radiator 100 and the resonant frequency of the second mode of the radiator 100 both increase. Herein, the resonant current of the first mode of the radiator 100 and the resonant current of the second mode of the radiator 100 are perpendicular to each other. In case that the first breakpoint 300 is located both in the current weak zone 102 of the first mode and the current strong zone 101 of the second mode, for the first mode, the series-connected first capacitor C1 has a relatively small impact on the original current distribution of the radiator 100, and the increase in the resonant frequency of the first mode of the radiator 100 is relatively small. For the second mode, the series-connected first capacitor C1 has a relatively large impact on the original current distribution of the radiator 100, and the increase in the resonance frequency of the second mode of the radiator 100 is relatively large. By adjusting the position of the first breakpoint 300 and/or the capacitance of the first capacitor C1, the difference between the resonance phase of the first mode and the resonance phase of the second mode is enabled to reach 90°, and then the radiator 100 forms a circularly polarized antenna.

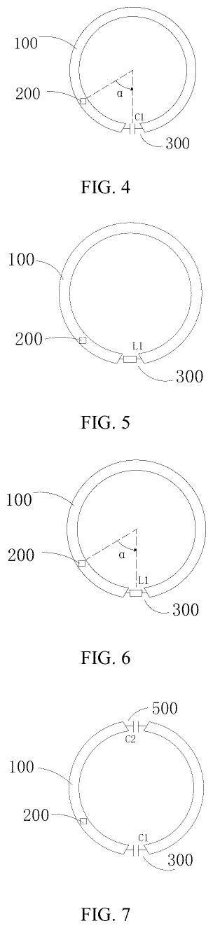

As shown in FIG. 4, when the first capacitor C1 is connected in series with the radiator at the first breakpoint 300, the line connecting the first feed terminal 200 and a center of the radiator 100 is a first line, the line connecting the first breakpoint 300 and the center of the radiator 100 is a second line, and a counterclockwise direction facing an upper surface of the radiator 100 is a first direction. Along the first direction, the first line and the second line form a first angle α, where α∈(0,π/2)∪(π,3π/2); or alternatively, α=(π/2,n)∪(3π/2,2π).

Particularly, the line connecting the first feed terminal 200 and the center of the radiator 100 is the first line, that is, the line connecting the feed point (the contact point between the first feed terminal 200 and the radiator 100) and the center of the radiator 100 is the first line. Given that the first breakpoint 300 is quite small in length, the line connecting the first breakpoint 300 and the center of the radiator 100 can serve as the second line. Optionally, the line connecting the center of the first breakpoint 300 and the center of the radiator 100 may serve as the second line.

When α=(0,π/2)∪(π,3π/2), the first breakpoint 300 is located at an intersection region where the current weak zone 102 of the first mode and the current strong zone 101 of the second mode of the radiator 100 converge, i.e., the first capacitor C1 is connected in series with the radiator at the junction area between the current weak zone 102 of the first mode and the current strong zone 101 of the second mode of the radiator 100. The resonant frequency of the first mode of the radiator 100 increases slightly, and the resonant frequency of the second mode of the radiator 100 increases significantly. Eventually, the difference between the resonant phase of the first mode and the resonant phase of the second mode reach 90°, forming a circularly polarized antenna.

When α∈(π/2,π)∪(3π/2,2π), the first breakpoint 300 is located at an intersection region where the current strong zone 101 of the first mode and the current weak zone 102 of the second mode of the radiator 100 converge, i.e., the first capacitor C1 is connected in series with the radiator at the junction area between the current strong zone 101 of the first mode and the current weak zone 102 of the second mode of the radiator 100. The resonant frequency of the first mode of the radiator 100 increases significantly, and the resonant frequency of the second mode of the radiator 100 increases slightly. Eventually, the difference between the resonant phase of the first mode and the resonant phase of the second mode reaches 90°, forming a circularly polarized antenna.

The circularly polarized antenna is a right-hand circularly polarized antenna when α∈(0,π/2)∪(π,3π/2). The circularly polarized antenna is a left-hand circularly polarized antenna when α∈(π/2,π)∪(3π/2,2π). Optionally, α∈(0,π/3)∪(π,4π/3); or alternatively, α∈(2π/3,π)∪(5π/3,2π)

As shown in FIG. 5, when the first inductor L1 is connected in series with the radiator at the first breakpoint 300 on the radiator 100, the equivalent distributed inductance of the radiator 100 will increase, the resonant frequency of the first mode and the resonant frequency of the second mode of the radiator 100 will both decrease, and the resonant current of the first mode of the radiator 100 and the resonant current of the second mode of the radiator 100 are perpendicular to each other. In case that the first breakpoint 300 is located both in the current weak zone 102 of the first mode and the current strong zone 101 of the second mode, for the first mode, the series-connected first inductor L1 has a relatively small impact on the original current distribution of the radiator 100, and the reduction in the resonant frequency of the first mode of the radiator 100 is relatively small. For the second mode, the series-connected first inductor L1 has a relatively large impact on the original current distribution of the radiator 100, and the reduction in the resonant frequency of the second mode of the radiator 100 is relatively large. By adjusting the position of the first breakpoint 300 and/or the inductance of the first inductor L1, the difference between the resonant phase of the first mode and the resonant phase of the second mode is enabled to reach 90°, and then the radiator 100 forms a circularly polarized antenna.

As shown in FIG. 6, when the first inductor L1 is connected in series with the radiator at the first breakpoint 300, the line connecting the first feed terminal 200 and the center of the radiator 100 is the first line, the line connecting the first breakpoint 300 and the center of the radiator 100 is the second line, the counterclockwise direction of the upper surface facing the radiator 100 is the first direction, and along the first direction, the first line and the second line form a first angle α, where α=(0,π/2)∪(π,3π/2); or alternatively, α=(π/2,π)∪(3π/2,2π).

Particularly, the line connecting the first feed terminal 200 and the center of the radiator 100 is the first line, that is, the line connecting the feed point (the contact point between the first feed terminal 200 and the radiator 100) and the center of the radiator 100 is the first line. Given that the first breakpoint 300 is quite small in length, the line connecting the first breakpoint 300 and the center of the radiator 100 can serve as the second line. Optionally, the line connecting the center of the first breakpoint 300 and the center of the radiator 100 may serve as the second line.

When α∈(0,π/2)∪(π,3π/2), the first breakpoint 300 is located at the intersection region where the current weak zone 102 of the first mode and the current strong zone 101 of the second mode of the radiator 100 converge, i.e., the first inductor L1 is connected in series with the radiator at the junction area between the current weak zone 102 of the first mode and the current strong zone 101 of the second mode of the radiator 100. The resonant frequency of the first mode of the radiator 100 decreases slightly, while the resonant frequency of the second mode of the radiator 100 decreases significantly. As a result, the phase difference between the resonant phases of the first mode and the second mode reaches 90°, forming a circularly polarized antenna.

When α∈(π/2,π)∪(3π/2,2π), the first breakpoint 300 is located at the intersection region where the current strong zone 101 of the first mode and the current weak zone 102 of the second mode of the radiator 100 converge, i.e., the first inductor L1 is connected in series with the radiator at the junction area between the current strong zone 101 of the first mode and the current weak zone 102 of the second mode of the radiator 100. The resonant frequency of the first mode of radiator 100 decreases significantly, while the resonant frequency of the second mode of the radiator 100 decreases slightly. As a result, the phase difference between the resonant phases of the first mode and the second mode reaches 90°, forming a circularly polarized antenna.

The circularly polarized antenna is a left-hand circularly polarized antenna when α∈(0,π/2)∪(π,3π/2). The circularly polarized antenna is a right-hand circularly polarized antenna when α∈(π/2,π)∪(3π/2,2π). Optionally, α∈(0,π/3) (π,4π/3) or α=(2π/3,π)∪(5π/3,2π).

In one embodiment of the present application, a second breakpoint 500 is also provided on the radiator 100, and a second capacitor C2 or a second inductor L2 is connected in series with the radiator at the second breakpoint 500.

Particularly, the first breakpoint 300 and the second breakpoint 500 are provided on the radiator 100, and a capacitor or an inductor may be connected in series with the radiator at both the first breakpoint 300 and the second breakpoint 500. In this case, the circularly polarized antenna may be implemented in the following three ways.

In a first implementation, as shown in FIG. 7, the first capacitor C1 is connected in series with the radiator at the first breakpoint 300, and the second capacitor C2 is connected in series with the radiator at the second breakpoint 500. The first capacitor C1 and the second capacitor C2 may be symmetrically arranged with respect to the center of the radiator 100, or may not be symmetrically arranged with respect to the center of the radiator 100. The first breakpoint 300 and the second breakpoint 500 are both arranged at the intersection region where the current weak zone 102 of the first mode and the current strong zone 101 of the second mode of the radiator 100 converge, i.e., the first capacitor C1 and the second capacitor C2 are respectively connected in series with the radiator at the junction area between the current weak zone 102 of the first mode and the current strong zone 101 of the second mode of the radiator 100. Optionally, the first breakpoint 300 and the second breakpoint 500 may be respectively arranged at the region where the current in the first mode of the radiator 100 is minimum while in the second mode is maximum. This facilitates the difference between the resonant phase of the first mode and the resonant phase of the second mode to reach 90°, thereby the radiator 100 forms a circularly polarized antenna.

The line connecting the first feed terminal 200 and the center of the radiator 100 is the first line, the line connecting the first breakpoint 300 and the center of the radiator 100 is the second line, and a line connecting the second breakpoint 500 and the center of the radiator 100 is a third line. The counterclockwise direction facing the upper surface of the radiator 100 is the first direction. Along the first direction, the first line and the second line form a first angle α, where α∈(0,π/2)∪(π,3π/2); or alternatively, α∈(π/2,π)∪(3π/2,2π). The first line and the third line form a second angle, where β∈(0,π/2)∪(π,3π/2); or alternatively, β∈(π/2,π)∪(3π/2,2π). Optionally, β∈(0,π/3)∪(π,4π/3); or alternatively, β∈(2π/3,π)∪(5π/3,2π).

The circularly polarized antenna is a right-hand circularly polarized antenna when α∈(0,π/2π) (π,3π/2) and β∈(0,π/2π)∪(π,3π/2).

The circularly polarized antenna is a left-hand circularly polarized antenna when α∈(π/2,π)∪(3π/2,2π) and β∈(π/2,π)∪(3π/2,2π).

In case that α=(0,π/2)∪(π,3π/2) and β∈(π/2,π)∪(3π/2,2), the first capacitor C1 enables the radiator 100 to form a right-hand circularly polarized antenna, and the second capacitor C2 enables the radiator 100 to form a left-hand circularly polarized antenna. If the capability of the first capacitor C1 to drive current rotation on the radiator 100 for right-hand circular polarization is stronger than the capability of the second capacitor C2 to drive current rotation on the radiator 100 for left-hand circular polarization, then the radiator 100 ultimately forms a right-hand circularly polarized antenna. On the contrary, the radiator 100 ultimately forms a left-hand circularly polarized antenna.

In case that α∈(π/2,π)∪(3π/2,2π), and β∈(0,π/2π)∪(π,3π/2), the first capacitor C1 enables the radiator 100 to form a left-hand circularly polarized antenna, and the second capacitor C2 enables the radiator 100 to form a right-hand circularly polarized antenna. If the capability of the first capacitor C1 to drive current rotation on the radiator 100 for left-hand circular polarization is stronger than the capability of the second capacitor C2 to drive current rotation on the radiator 100 for right-hand circular polarization, then the radiator 100 ultimately forms a left-hand circularly polarized antenna. On the contrary, the radiator 100 ultimately forms a right-hand circularly polarized antenna.

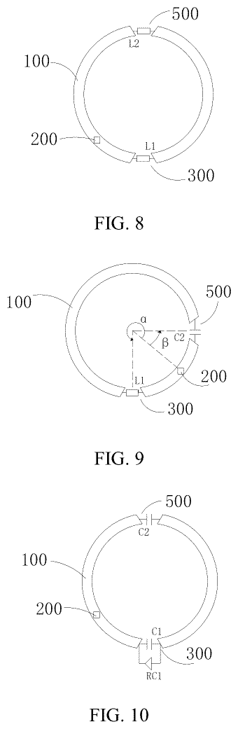

In a second implementation, as shown in FIG. 8, the first inductor L1 is connected in series with the radiator at the first breakpoint 300 and the second inductor L2 is connected in series with the radiator at the second breakpoint 500. The first inductor L1 and the second inductor L2 may be symmetrically arranged with respect to the center of the radiator 100, or may not be symmetrically arranged with respect to the center of the radiator 100. The first breakpoint 300 and the second breakpoint 500 are both arranged at the intersection region where the current weak zone 102 of the first mode and the current strong zone 101 of the second mode of the radiator 100 converge, i.e., the first inductor L1 and the second inductor L2 are both connected in series with the radiator at the junction area between the current weak zone 102 of the first mode and the current strong zone 101 of the second mode of the radiator 100. Optionally, the first breakpoint 300 and the second breakpoint 500 may be respectively arranged at the region where the current in the first mode of the radiator 100 is minimum while in the second mode is maximum. This makes it easier to achieve a phase difference of 90° between the resonant phase of the first mode and the resonant phase of the second mode, thereby the radiator 100 forms a circularly polarized antenna.

The line connecting the first feed terminal 200 and the center of the radiator 100 is the first line, the line connecting the first breakpoint 300 and the center of the radiator 100 is the second line, and the line connecting the second breakpoint 500 and the center of the radiator 100 is the third line. The counterclockwise direction of the upper surface facing the radiator 100 is the first direction. Along the first direction, the first line and the second line form the first angle α, where α∈(0,π/2π)∪(π,3π/2); or alternatively, α∈(π/2,π)∪(3π/2,2π). The first line and the third line form the second angle β, where β∈(0,π/2π) (π,3π/2); or alternatively, β∈(π/2,π)∪(3π/2,2π).

The circularly polarized antenna is a left-hand circularly polarized antenna when α=(0,π/2π)∪(π,3π/2) and β∈(0,π/2π)∪(π,3π/2).

The circularly polarized antenna is a right-hand circularly polarized antenna when α∈(π/2,π)∪(3π/2,2π) and β∈(π/2,π)∪(3π/2,2π).

In case that α∈(0,π/2π)∪(π,3π/2) and β∈(π/2,π)∪(3π/2,2π), the first inductor L1 enables the radiator 100 to form a left-hand circularly polarized antenna, and the second inductor L2 enables the radiator 100 to form a right-hand circularly polarized antenna. If the capability of the first inductor L1 to drive current rotation on the radiator 100 for left-hand circular polarization is stronger than that of the second inductor L2 to drive current rotation on the radiator 100 for right-hand circular polarization, then the radiator 100 ultimately forms a left-hand circularly polarized antenna. On the contrary, the radiator 100 ultimately forms a right-hand circularly polarized antenna.

In case that α∈(π/2,π)∪(3π/2,2π) and β∈(0,π/2) (π,3π/2), the first inductor L1 enables the radiator 100 form a right-hand circularly polarized antenna, and the second inductor L2 enables the radiator 100 form a left-hand circularly polarized antenna. If the capability of the first inductor L1 to drive current rotation on the radiator 100 for right-hand circular polarization is stronger than the capability of the second inductor L2 to drive current rotation on the radiator 100 for left-hand circular polarization, then the radiator 100 ultimately forms a right-hand circularly polarized antenna. On the contrary, the radiator 100 ultimately forms a left-hand circularly polarized antenna.

In a third implementation, as shown in FIG. 9, the first inductor L1 is connected in series with the radiator at the first breakpoint 300, and the second capacitor C2 is connected in series with the radiator at the second breakpoint 500. The first breakpoint 300 and the second breakpoint 500 are respectively arranged at an intersection region where the current weak zone 102 of the first mode and the current strong zone 101 of the second mode of the radiator 100 converge, i.e., the first inductor L1 and the second capacitor C2 are respectively connected in series with the radiator at the junction area between the current weak zone 102 of the first mode and the current strong zone 101 of the second mode of the radiator 100. Optionally, the first breakpoint 300 and the second breakpoint 500 may be respectively arranged at the region where the current in the first mode of the radiator 100 is minimum while in the second mode is the maximum. This makes it easier to achieve the phase difference of 90° between the resonant phase of the first mode and the resonant phase of the second mode, thereby the radiator 100 forms a circularly polarized antenna.

The line connecting the first feed terminal 200 and the center of the radiator 100 is the first line, the line connecting the first breakpoint 300 and the center of the radiator 100 is the second line, and the line connecting the second breakpoint 500 and the center of the radiator 100 is the third line. The counterclockwise direction facing the upper surface of the radiator 100 is the first direction. Along the first direction, the first line and the second line form the first angle α, where α∈(0,π/2π)∪(π,3π/2); or alternatively, α∈(π/2,π)∪(3π/2,2π). The first line and the third line form the second angle β, where β∈(0,π/2π)∪(π,3π/2); or alternatively, β∈(π/2,π)∪(3π/2,2π).

The circularly polarized antenna is a left-hand circularly polarized antenna when α=(0,π/2π)∪(π,3π/2) and β∈(π/2,π)∪(3π/2,2π).

The circularly polarized antenna is a right-hand circularly polarized antenna when α=(π/2,π)∪(3π/2,2π) and β∈(0,π/2π)∪(π,3π/2).

In case that α∈(0,π/2π)∪(π,3π/2) and β∈(0,π/2π)∪(π,3π/2), the first inductor L1 enables the radiator 100 to form a left-hand circularly polarized antenna, and the second capacitor C2 enables the radiator 100 to form a right-hand circularly polarized antenna. If the capability of the first inductor L1 to drive the current rotation on the radiator 100 for left-hand circular polarization is stronger than the capability of the second capacitor C2 to drive the current rotation on the radiator 100 for right-hand circular polarization, then the radiator 100 ultimately forms a left-hand circularly polarized antenna. On the contrary, the radiator 100 ultimately forms a right-hand circularly polarized antenna.

When α∈(π/2,π)∪(3π/2,2π) and β∈(π/2,π)∪(3π/2,2π), the first inductor L1 enables the radiator 100 to form a right-hand circularly polarized antenna, and the second capacitor C2 enables the radiator 100 to form a left-hand circularly polarized antenna. If the capability of the first inductor L1 to drive the current rotation on the radiator 100 for right-hand circular polarization is stronger than the capability of the second capacitor C2 to drive the current rotation on the radiator 100 for left-hand circular polarization, then the radiator 100 ultimately forms a right-hand circularly polarized antenna. On the contrary, the radiator 100 ultimately forms a left-hand circularly polarized antenna.

In one embodiment of the present application, at least one third breakpoint is also provided on the radiator 100, and a third capacitor or a third inductor is connected in series with the radiator at the third breakpoint.

Particularly, the radiator 100 includes a first breakpoint 300, a second breakpoint 500 and at least one third breakpoint. Herein, the first capacitor C1 or the first inductor L1 may be connected in series with the radiator at the first breakpoint 300. The second capacitor C2 or the second inductor L2 may be connected in series with the radiator at the second breakpoint 500, and the third capacitor or the third inductor may be connected in series with the radiator at each third breakpoint. By adjusting the positions of the first breakpoint 300, the second breakpoint 500 and the third breakpoint(s) on the radiator 100, and/or adjusting the capacitance of the capacitor and the inductance of the inductor connected in series with the radiator at the breakpoint, the difference between the resonant phase of the first mode and the resonant phase of the second mode is enabled to reach 90°, thereby the radiator 100 forms a circularly polarized antenna. For the specific design principle, references may be made to the description of designing the first breakpoint 300 and the second breakpoint 500 on the radiator 100, which will not be repeated here.

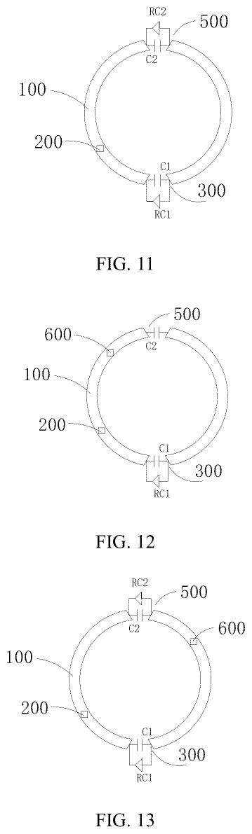

As shown in FIG. 10, the circularly polarized antenna also includes a first filter RC1. The first filter RC1 is used to filter signals of other communication frequency bands except a signal of a second communication frequency band. the signal of the second communication frequency band is a signal of a working frequency band of the circularly polarized antenna formed by the first feed terminal 200, the radiator 100 and the second capacitor C2. Or alternatively, the signal of the second communication frequency band is a signal of a working frequency band of the circularly polarized antenna formed by the first feed terminal 200, the radiator 100 and the second inductor L2.

Particularly, the first filter RC1 is used to filter signals of other communication frequency bands except the signal of the second communication frequency band. At this point, the signal of the second communication frequency band is a signal of the working frequency band of the circularly polarized antenna formed by the first feed terminal 200, the radiator 100 and the second capacitor C2. Or alternatively, the signal of the second communication frequency band is a signal of the working frequency band of the circularly polarized antenna formed by the first feed terminal 200, the radiator 100 and the second inductor L2.

In this case, a signal of a first communication frequency band refers to a signal of a working frequency band of the circularly polarized antenna formed by the first feed terminal 200, the radiator 100, the first capacitor C1 and the second capacitor C2. Or alternatively, the signal of the first communication frequency band refers to a signal of a working frequency band of the circularly polarized antenna formed by the first feed terminal 200, the radiator 100, the first capacitor C1 and the second inductor L2. Or alternatively, the signal of the first communication frequency band refers to a signal of a working frequency band of the circularly polarized antenna formed by the first feed terminal 200, the radiator 100, the first inductor L1 and the second capacitor C2. Or alternatively, the signal of the first communication frequency band refers to a signal of a working frequency band of the circularly polarized antenna formed by the first feed terminal 200, the radiator 100, the first inductor L1 and the second inductor L2.

Thus, the second communication band signal can only propagate through the circularly polarized antenna formed by the first feed terminal 200, the radiator 100, and the second capacitor C2. Or alternatively, the second communication band signal can only propagate through the circularly polarized antenna formed by the first feed terminal 200, the radiator 100, and the second inductor L2.

the signal of the first communication frequency band can only propagate through the circularly polarized antenna formed by the first feed terminal 200, the radiator 100, the first capacitor C1 and the second capacitor C2. Or alternatively, the signal of the first communication frequency band can only propagate through the circularly polarized antenna formed by the first feed terminal 200, the radiator 100, the first capacitor C1 and the second inductor L2. Or alternatively, the signal of the first communication frequency band can only propagate through the circularly polarized antenna formed by the first feed terminal 200, the radiator 100, the first inductor L1 and the second inductor L2. Or alternatively, the signal of the first communication frequency band can only propagate through the circularly polarized antenna formed by the first feed terminal 200, the radiator 100, the first inductor L1 and the second inductor L2.

It can be concluded that the signal of the first communication frequency band and the signal of the second communication frequency band do not interfere with each other. By adjusting the capacitance of the first capacitor C1 or the inductance of the first inductor L1 at the first breakpoint 300, and/or adjusting the capacitance of the second capacitor C2 or the inductance of the second inductor L2 at the second breakpoint 500, the circular polarization characteristics of the signal of the first communication frequency band and the signal of the second communication frequency band can be adjusted, and finally, the radiator 1000 forms a dual-frequency circularly polarized antenna.

Exemplarily, the first filter RC1 is connected in parallel with the first capacitor C1 (as shown in FIG. 10), or the first filter RC1 is connected in parallel with the first inductor L1 (not shown in the figure). The first filter RC1 may be a bandpass filter.

As shown in FIG. 11, the circularly polarized antenna further includes a second filter RC2. The second filter RC2 is used to filter signals of other communication frequency bands except the signal of the first communication frequency band. the signal of the first communication frequency band is a signal of a working frequency band of the circularly polarized antenna formed by the first feed terminal 200, the radiator 100 and the first capacitor C1. Or alternatively, the signal of the first communication frequency band is a signal of a working frequency band of the circularly polarized antenna formed by the first feed terminal 200, the radiator 100 and the first inductor L1.

Particularly, the second filter RC2 is used to filter signals of other communication frequency bands except the signal of the first communication frequency band. In this case, the signal of the first communication frequency band refers to the signal of the working frequency band of the circularly polarized antenna formed by the first feed terminal 200, the radiator 100 and the first capacitor C1. Or alternatively, the signal of the first communication frequency band refers to the signal of the working frequency band of the circularly polarized antenna formed by the first feed terminal 200, the radiator 100 and the first inductor L1.

The first filter RC1 is used to filter signals of other communication frequency bands except the signal of the second communication frequency band. In this case, the signal of the second communication frequency band refers to the signal of the working frequency band of the circularly polarized antenna formed by the first feed terminal 200, the radiator 100 and the second capacitor C2. Or alternatively, the signal of the second communication frequency band refers to the signal of the working frequency band of the circularly polarized antenna formed by the first feed terminal 200, the radiator 100 and the second inductor L2.

Thus, the signal of the first communication frequency band can only propagate through the circularly polarized antenna formed by the first feed terminal 200, the radiator 100 and the first capacitor C1. Or alternatively, the signal of the first communication frequency band can only propagate through the circularly polarized antenna formed by the first feed terminal 200, the radiator 100 and the first inductor L1. the signal of the second communication frequency band can only propagate through the circularly polarized antenna formed by the first feed terminal 200, the radiator 100 and the second capacitor C2. Or alternatively, the signal of the second communication frequency band can only propagate through the circularly polarized antenna formed by the first feed terminal 200, the radiator 100 and the second inductor L2.

It can be concluded that the signal of the first communication frequency band and the signal of the second communication frequency band do not interfere with each other. By adjusting the capacitance of the first capacitor C1 or the inductance of the first inductor L1 at the first breakpoint 300, and/or adjusting the capacitance of the second capacitor C2 or the inductance of the second inductor L2 at the second breakpoint 500, the circular polarization characteristics of the signal of the first communication frequency band and the signal of the second communication frequency band can be adjusted, and finally the radiator 100 forms a dual-frequency circularly polarized antenna.

Exemplarily, the second filter RC2 is connected in parallel with the second capacitor C2 (as shown in FIG. 11), or alternatively, the second filter RC2 is connected in parallel with the second inductor L2 (not shown in the figure). The second filter RC2 may be a bandpass filter.

In one embodiment of the present application, the circularly polarized antenna also includes a third filter. The third filter is used to filter signals of other communication frequency bands except a signal of a third communication frequency band, the first filter is used to filter signals of other communication frequency bands except the signal of the second communication frequency band, and the second filter is used to filter signals of other communication frequency bands except the signal of the first communication frequency band.

In this case, the signal of the first communication frequency band refers to a signal of a working frequency band of the circularly polarized antenna formed by the first feed terminal 200, the radiator 100, the first inductor L1 and the third capacitor. Or alternatively, the signal of the first communication frequency band refers to a signal of a working frequency band of the circularly polarized antenna formed by the first feed terminal 200, the radiator 100, the first inductor L1 and the third inductor. Or alternatively, the signal of the first communication frequency band refers to a signal of a working frequency band of the circularly polarized antenna formed by the first feed terminal 200, the radiator 100, the first capacitor C1 and the third capacitor. Or alternatively, the signal of the first communication frequency band refers to a signal of a working frequency band of the circularly polarized antenna formed by the first feed terminal 200, the radiator 100, the first capacitor C1 and the third inductor.

the signal of the second communication frequency band refers to a signal of a working frequency band of the circularly polarized antenna formed by the first feed terminal 200, the radiator 100, the second inductor L2 and the third capacitor. Or alternatively, the signal of the second communication frequency band refers to a signal of a working frequency band of the circularly polarized antenna formed by the first feed terminal 200, the radiator 100, the second inductor L2 and the third inductor. Or alternatively, the signal of the second communication frequency band refers to a signal of a working frequency band of the circularly polarized antenna formed by the first feed terminal 200, the radiator 100, the second capacitor C2 and the third capacitor. Or alternatively, the signal of the second communication frequency band refers to a signal of a working frequency band of the circularly polarized antenna formed by the first feed terminal 200, the radiator 100, the second capacitor C2 and the third inductor.

the signal of the third communication frequency band refers to the signal of the working frequency band of the circularly polarized antenna formed by the first feed terminal 200, the radiator 100, the first inductor L1 and the second inductor L2. Or alternatively, the signal of the third communication frequency band refers to the signal of the working frequency band of the circularly polarized antenna formed by the first feed terminal 200, the radiator 100, the first inductor L1 and the second capacitor C2. Or alternatively, the signal of the third communication frequency band refers to the signal of the working frequency band of the circularly polarized antenna formed by the first feed terminal 200, the radiator 100, the first capacitor C1 and the second inductor L2. Or alternatively, the signal of the third communication frequency band refers to the signal of the working frequency band of the circularly polarized antenna formed by the first feed terminal 200, the radiator 100, the first capacitor C1 and the second capacitor C2.

Thus, the signal of the first communication frequency band can only propagate through the circularly polarized antenna formed by the first feed terminal 200, the radiator 100, the first inductor L1 and the third capacitor. Or alternatively, the signal of the first communication frequency band can only propagate through the circularly polarized antenna formed by the first feed terminal 200, the radiator 100, the first inductor L1 and the third inductor. Or alternatively, the signal of the first communication frequency band can only propagate through the circularly polarized antenna formed by the first feed terminal 200, the radiator 100, the first capacitor C1 and the third capacitor. Or alternatively, the signal of the first communication frequency band can only propagate through the circularly polarized antenna formed by the first feed terminal 200, the radiator 100, the first capacitor C1 and the third inductor.

the signal of the second communication frequency band can only propagate through the circularly polarized antenna formed by the first feed terminal 200, the radiator 100, the second inductor L2 and the third capacitor. Or alternatively, the signal of the second communication frequency band can only propagate through the circularly polarized antenna formed by the first feed terminal 200, the radiator 100, the second inductor L2 and the third inductor. Or alternatively, the signal of the second communication frequency band can only propagate through the circularly polarized antenna formed by the first feed terminal 200, the radiator 100, the second capacitor C2 and the third capacitor. Or alternatively, the signal of the second communication frequency band can only propagate through the circularly polarized antenna formed by the first feed terminal 200, the radiator 100, the second capacitor C2 and the third inductor.

the signal of the third communication frequency band can only propagate through the circularly polarized antenna formed by the first feed terminal 200, the radiator 100, the first inductor L1 and the second inductor L2. Or alternatively, the signal of the third communication frequency band can only propagate through the circularly polarized antenna formed by the first feed terminal 200, the radiator 100, the first inductor L1 and the second capacitor C2. Or alternatively, the signal of the third communication frequency band can only propagate through the circularly polarized antenna formed by the first feed terminal 200, the radiator 100, the first capacitor C1 and the second inductor L2. Or alternatively, the signal of the third communication frequency band can only propagate through the circularly polarized antenna formed by the first feed terminal 200, the radiator 100, the first capacitor C1 and the second capacitor C2.

It can be concluded that the signal of the first communication frequency band, the signal of the second communication frequency band and the signal of the third communication frequency band do not interfere with each other. By adjusting the capacitance of the first capacitor C1 or the inductance of the first inductor L1 at the first breakpoint 300, and/or adjusting the capacitance of the second capacitor C2 or the inductance of the second inductor L2 at the second breakpoint 500, and/or adjusting the capacitance of the third capacitor or the inductance of the third inductor at the third breakpoint, the circular polarization characteristics of the signal of the first communication frequency band, the signal of the second communication frequency band and the signal of the third communication frequency band can be adjusted, and finally the radiator 100 forms a triple-frequency circularly polarized antenna.

Exemplarily, the third filter is connected in parallel with the third capacitor, or alternatively, the third filter is connected in parallel with the third inductor.

Similarly, three or more breakpoints may be arranged on the radiator 100, and a capacitor or an inductor is connected in series with the radiator at each breakpoint, and the radiator 100 is enabled to form a multi-frequency circularly polarized antenna when a filter is connected in series with the radiator at each breakpoint. The principle of the multi-frequency circularly polarized antenna is the same as the above description, which is not repeated here.

In another embodiment of the present application, the circularly polarized antenna also includes a third filter. In this case, the first filter only allows the signal of the second communication frequency band and the signal of the third communication frequency band to propagate. The second filter only allows the signal of the first communication frequency band and the signal of the third communication frequency band to propagate. The third filter only allows the signal of the first communication frequency band and the signal of the second communication frequency band to propagate. the signal of the first communication frequency band is the signal of the working frequency band of the circularly polarized antenna formed by the first feed terminal 200, the radiator 100 and the first inductor L1. Or alternatively, the signal of the first communication frequency band is the signal of the working frequency band of the circularly polarized antenna formed by the first feed terminal 200, the radiator 100 and the first capacitor C1. the signal of the second communication frequency band is the signal of the working frequency band of the circularly polarized antenna formed by the first feed terminal 200, the radiator 100 and the second inductor L2. Or alternatively, the signal of the second communication frequency band is the signal of the working frequency band of the circularly polarized antenna formed by the first feed terminal 200, the radiator 100 and the second capacitor C2. the signal of the third communication frequency band is the signal of the working frequency band of the circularly polarized antenna formed by the first feed terminal 200, the radiator 100 and the third inductor L3. Or alternatively, the signal of the third communication frequency band is a signal of the working frequency band of the circularly polarized antenna formed by the first feed terminal 200, the radiator 100 and the third capacitor C3.

It can be concluded that the signal of the first communication frequency band, the signal of the second communication frequency band and the signal of the third communication frequency band do not interfere with each other. By adjusting the capacitance of the first capacitor C1 or the inductance of the first inductor L1 at the first breakpoint 300, and/or adjusting the capacitance of the second capacitor C2 or the inductance of the second inductor L2 at the second breakpoint 500, and/or adjusting the capacitance of the third capacitor or the inductance of the third inductor at the third breakpoint, the circular polarization characteristics of the signal of the first communication frequency band, the signal of the second communication frequency band and the signal of the third communication frequency band can be adjusted, and finally the radiator 100 forms a triple-frequency circularly polarized antenna.

Exemplarily, the third filter is connected in parallel with the third capacitor, or alternatively, the third filter is connected in parallel with the third inductor.

In addition, a plurality of filters arranged in parallel may be connected at each of the three breakpoints of the radiator, and the plurality of filters allow signals of multiple frequency bands to propagate, thereby achieving a three-frequency circularly polarized antenna.

Similarly, three or more breakpoints may be arranged on the radiator 100, and a capacitor or an inductor is connected in series with the radiator at each breakpoint, and at least one filter is connected at each breakpoint, so that the radiator 100 can form a multi-frequency circularly polarized antenna. The principle of the multi-frequency circularly polarized antenna is the same as the above description and will not be repeated here.

As shown in FIG. 12, the circularly polarized antenna also includes a second feed terminal 600, one end of the second feed terminal 600 is electrically connected to the radiator 100, and the other end of the second feed terminal 600 is electrically connected to a second feed module on the mainboard 400.

Particularly, when the radiator 100 is provided with the first breakpoint 300 and the second breakpoint 500, the first capacitor C1 or the first inductor L1 is connected in series with the radiator at the first breakpoint 300, the second capacitor C2 or the second inductor L2 is connected in series with the radiator at the second breakpoint 500, and the first filter RC1 is connected in parallel with the first capacitor C1 or the first inductor L1, the radiator 100 forms a dual-frequency circularly polarized antenna.

In case that the circularly polarized antenna includes the first feed terminal 200 and the second feed terminal 600, the first feed module on the mainboard 400 connected to the first feed terminal 200 may be a GPS module, in which case the first feed module is used to receive a GPS signal of one frequency band, and the second feed module on the mainboard 400 connected to the second feed terminal 600 may be a Bluetooth module or a WiFi module, in which case the second feed module is used to receive Bluetooth or WiFi signals. Thus, the circularly polarized antenna can achieve simultaneous excitation and reception of single-frequency GPS signals and Bluetooth or WiFi signals.

The positioning method for the connection point between the second feed terminal 600 and the radiator 100 is consistent with the method for determining the location of the first feed terminal 200 described above, which will not be repeated here.

As shown in FIG. 13, when the radiator 100 is provided with the first breakpoint 300 and the second breakpoint 500, the first breakpoint 300 is connected in series with the first capacitor C1 or the first inductor L1, the second breakpoint 500 is connected in series with the second capacitor C2 or the second inductor L2, the first filter RC1 is connected in parallel with the first capacitor C1 or the first inductor L1, and the second filter RC2 is connected in parallel with the second capacitor C2 or the second inductor L2, the radiator 100 forms a dual-frequency circularly polarized antenna. Since the frequency of the signal that the antenna can excite or receive is in a multiple frequency relationship, for instance, the antenna may excite or receive signals in the f₀ frequency band, signals in the 2f₀ frequency band, and signals in the 3f₀ frequency band. Particularly, the frequency of the GPS signal in the L5 band is approximately 1.176 GHZ, and the frequency of the Bluetooth signal or the WiFi signal is 2.4 GHZ. The frequency of the Bluetooth signal or the WiFi signal is approximately twice the frequency of the GPS signal in the L5 band. Thus, when the circularly polarized antenna can excite or receive the GPS signal in the L5 band, the circularly polarized antenna can also receive the Bluetooth signal or the WiFi signal simultaneously.

In case that the circularly polarized antenna includes the first feed terminal 200 and the second feed terminal 600, the first feed module on the mainboard 400 connected to the first feed terminal 200 may be a GPS module, in which case the first feed module is used to receive the GPS signal, and the second feed module on the mainboard 400 connected to the second feed terminal 600 may be a Bluetooth module or a WiFi module, in which case the second feed module is used to receive the Bluetooth or WiFi signal. Thus, the circularly polarized antenna can realize the simultaneous excitation and reception of dual-frequency GPS signals and Bluetooth or WiFi signals.

The positioning method for the connection point between the second feed terminal 600 and radiator 100 is consistent with the aforementioned method used for determining the location of the first feed terminal 200, and thus is not repeated here.

The present application also discloses an intelligent terminal, which includes the circularly polarized antenna described above. Since one annular radiator is used in the circularly polarized antenna, the space occupied by the antenna is reduced. Therefore, the intelligent terminal is more conducive to realizing a miniaturization design.

The intelligent terminal of the present application may be a mobile phone, a tablet and an intelligent wearable device. The intelligent wearable device may be an intelligent watch, an intelligent bracelet, an intelligent headset or an intelligent pair of glasses.

The above embodiments are merely used to illustrate rather than limit the technical solutions of the present application. Although the present application is described in detail with reference to the above embodiments, ordinary technicians in this field should understand that the technical solutions recorded in the above embodiments may still be modified, or some of the technical features therein may be substituted by equivalents. These modifications or substitutions do not make the essence of the corresponding technical solutions deviate from the spirit and scope of the technical solutions of the embodiments of the present application, and thus should all be included within the protection scope of the present application.

What is claimed is:

1. A circularly polarized antenna, comprising:
an annular radiator, a first breakpoint is provided on the annular radiator, a first capacitor or a first inductor is connected in series with the annular radiator at the first breakpoint; and
a first feed terminal, one end of the first feed terminal is electrically connected to the annular radiator, and another end of the first feed terminal is electrically connected to a first feed module of a mainboard.

2. The circularly polarized antenna according to claim 1, wherein a line connecting the first feed terminal and a center of the annular radiator is a first line, a line connecting the first breakpoint and the center of the annular radiator is a second line, a counterclockwise direction of the annular radiator is a first direction, and along the first direction, the first line to the second line forms a first angle α;
wherein, α∈(0,π/2)∪(π,3π/2); or alternatively, α∈(π/2,π)∪(3π/2,2π).

3. The circularly polarized antenna according to claim 2, wherein,
α∈(0,π/3)∪(π,4π/3); or alternatively, α∈(2 π/3,π)∪(5π/3,2π).

4. The circularly polarized antenna according to claim 2, wherein a second breakpoint is further provided on the annular radiator, and a second capacitor or a second inductor is connected in series with the annular radiator at the second breakpoint.

5. The circularly polarized antenna according to claim 4, wherein the line connecting the first feed terminal and the center of the annular radiator is the first line, a line connecting the second breakpoint and the center of the annular radiator is a third line, the counterclockwise direction of the annular radiator is the first direction, and along the first direction, the first line to the third line forms a second angle β;
wherein, β∈(0,π/2π)∪(π,3π/2); or alternatively, β∈(π/2,π)∪(3π/2,2π).

6. The circularly polarized antenna according to claim 5, wherein,
β∈(0,π/3) (π,4π/3); or alternatively, β∈(2π/3,π)∪(5π/3,2π).

7. The circularly polarized antenna according to claim 4, wherein the circularly polarized antenna further comprises a first filter, the first filter is configured to filter signals of other communication frequency bands except a signal of a second communication frequency band, the signal of the second communication frequency band is a signal of a working frequency band of the circularly polarized antenna formed by the first feed terminal, the annular radiator and the second capacitor, or alternatively, the signal of the second communication frequency band is a signal of a working frequency band of the circularly polarized antenna formed by the first feed terminal, the annular radiator and the second inductor.

8. The circularly polarized antenna according to claim 7, wherein the first filter is connected in parallel with the first capacitor, or alternatively, the first filter is connected in parallel with the first inductor.

9. The circularly polarized antenna according to claim 7, wherein the circularly polarized antenna further comprises a second filter, the second filter is configured to filter signals of other communication frequency bands except a signal of a first communication frequency band, the signal of the first communication frequency band is a signal of a working frequency band of the circularly polarized antenna formed by the first feed terminal, the annular radiator and the first capacitor, or alternatively, the signal of the first communication frequency band is a signal of a working frequency band of the circularly polarized antenna formed by the first feed terminal, the annular radiator and the first inductor.

10. The circularly polarized antenna according to claim 9, wherein the second filter is connected in parallel with the second capacitor, or alternatively, the second filter is connected in parallel with the second inductor.

11. The circularly polarized antenna according to claim 7, wherein the circularly polarized antenna further comprises a second feed terminal, one end of the second feed terminal is electrically connected to the annular radiator, and another end of the second feed terminal is electrically connected to a second feed module on the mainboard.

12. The circularly polarized antenna according to claim 9, wherein the circularly polarized antenna further comprises a second feed terminal, one end of the second feed terminal is electrically connected to the annular radiator, and another end of the second feed terminal is electrically connected to a second feed module on the mainboard.

13. An intelligent terminal, comprising:
a circularly polarized antenna, comprising:
an annular radiator, a first breakpoint is provided on the annular radiator, a first capacitor or a first inductor is connected in series with the annular radiator at the first breakpoint; and
a first feed terminal, one end of the first feed terminal is electrically connected to the annular radiator, and another end of the first feed terminal is electrically connected to a first feed module of a mainboard.

14. The intelligent terminal according to claim 13, wherein a line connecting the first feed terminal and a center of the annular radiator is a first line, a line connecting the first breakpoint and the center of the annular radiator is a second line, a counterclockwise direction of the annular radiator is a first direction, and along the first direction, the first line to the second line forms a first angle α;
wherein, α∈(0,π/2π)∪(π,3π/2); or alternatively, α∈(π/2,π)∪(3π/2,2π).

15. The intelligent terminal according to claim 14, wherein α∈(0,π/3)∪(π,4π/3); or alternatively, α∈(2π/3,π)∪(5π/3,2π).

16. The intelligent terminal according to claim 14, wherein a second breakpoint is further provided on the annular radiator, and a second capacitor or a second inductor is connected in series with the annular radiator at the second breakpoint.

17. The intelligent terminal according to claim 16, wherein the line connecting the first feed terminal and the center of the annular radiator is the first line, a line connecting the second breakpoint and the center of the annular radiator is a third line, the counterclockwise direction of the annular radiator is the first direction, and along the first direction, the first line to the third line forms a second angle β;
wherein, β∈(0,π/2π)∪(π,3π/2); or alternatively, β∈(π/2,π)∪(3π/2,2π).

18. The intelligent terminal according to claim 17, wherein β∈(0,π/3)∪(π,4π/3); or alternatively, β∈(2π/3, π)∪(51/3,2π).

19. The intelligent terminal according to claim 16, wherein the circularly polarized antenna further comprises a first filter, the first filter is configured to filter signals of other communication frequency bands except a signal of a second communication frequency band, the signal of the second communication frequency band is a signal of a working frequency band of the circularly polarized antenna formed by the first feed terminal, the annular radiator and the second capacitor, or alternatively, the signal of the second communication frequency band is a signal of a working frequency band of the circularly polarized antenna formed by the first feed terminal, the annular radiator and the second inductor.

20. The intelligent terminal according to claim 19, wherein the first filter is connected in parallel with the first capacitor, or alternatively, the first filter is connected in parallel with the first inductor.
